(19) United States
(12) Patent Application Publication
(10) Pub. No.: US 2007/0001347 A1
(43) Pub. Date: Jan. 4, 2007

(54) METHOD AND DEVICE FOR THE PRODUCTION OF ELECTRIC CONDUCTORS WITH A SHEATHING

(75) Inventor: Bernd Pielsticker, Sarstedt (DE)

Correspondence Address: DARBY & DARBY P.C., P. O. BOX 5257, NEW YORK, NY, 10150-5257, US

(73) Assignee: TROESTER GmbH & Co., KG, Hannover (DE)

(21) Appl. No.: 11/427,931

(22) Filed: Jun. 30, 2006

(30) Foreign Application Priority Data
Jul. 1, 2005 (DE) DE102005031222.5

(51) Int. Cl. H05B 7/00

(52) U.S. Cl. 264/452; 264/464

(57) ABSTRACT

A method and a device for the production of electrically conductors, especially current-carrying lines, having a sheathing made of a thermoplastic material. An extrusion head having a bore that determines the outer circumference of the conductor is employed for this purpose. The bore is variably adjustable in order to set a different outer circumference of the conductor during the production process.

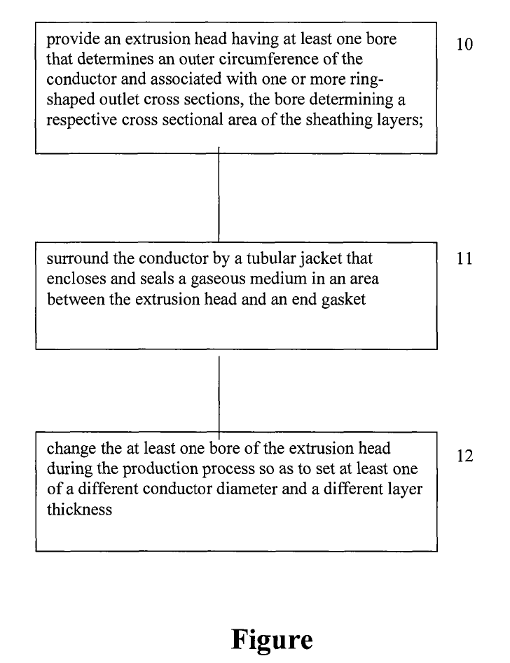

Priority is claimed to German Patent Application No. DE 102005031222.5, filed on Jul. 1, 2005, the entire disclosure of which is incorporated by reference herein.

The invention relates to a method for the production of electrically insulated conductors, especially current-carrying lines, having a sheathing made of one or more thermoplastic materials, the conductor being surrounded by a tubular jacket that encloses and seals a gaseous medium by means of an end gasket. Moreover, the invention relates to a device for the production of such electric conductors.

### BACKGROUND

Changing the dimensions during the extrusion of electric conductors is highly time-consuming in actual practice nowadays. In order to do so, the production line is completely stopped, thereby interrupting production. A great deal of personnel and time are needed for the retooling and replacement of the extrusion head insert having a given bore as well as of the extrusion dies that create the sheathing layers, and at times, these dies even have to be specially made for this purpose. Consequently, resuming the production process is associated with a large number of rejects. Therefore, flexible production of such conductors is hardly feasible in actual practice.

The properties of the electric conductors are substantially determined by the chemical cross-linking that takes place inside the tubular jacket that, for this purpose, is filled with a gaseous medium, especially with an inert gas such as nitrogen or saturated steam. The cross-linking is preferably carried out at pressures of up to 25 bar. Depending on the cable weight, the conductors or cores are produced on installations in which the jacket is oriented horizontally, vertically, obliquely or following a catenary curve.

World Patent Application WO 01/95345 A1, which is incorporated by reference herein, has already disclosed electric cables whose insulating sheathing varies along the length of the cable. In this manner, a sheathing is formed that is adapted to the requisite electrical insulation, so as to reduce the physical size, for example, in the case of windings, and so as to optimize the components made with such sheathing.

Moreover, U.S. Pat. No. 5,283,392, which is incorporated by reference herein, relates to an electric power cable line, especially an electric power cable, whose operational reliability is improved by increasing the dielectric strength of its straight joints and terminal ends in that the insulating layer is increased to a greater thickness at two end portions of each cable.

Moreover, German patent DE 578 997, which is incorporated by reference herein, relates to a line in which thickened places in the insulation concurrently serve for purposes of strain relief.

Moreover, German specifications DE 103 15 125 B3, DE 103 37 533 A1, DE 103 24 475 A1 and DE 103 23 543 A1, each of which are incorporated by reference herein, describe calibration devices for the calibration of extruded pipes that consist of a plurality of segmented bodies formed from individual segments arranged one behind the other. Several segments arranged one behind the other in the axial direction are combined to form a segment block that is held in the housing so as to be radially adjustable.

Moreover, German Utility Model DE 20 2004 006 793 U1, which is incorporated by reference herein, discloses a device for the production of tubes made of thermoplastic material, whereby the format of the tube can be adjusted by an adjustable passage gap and by a downstream calibration unit that determines the outer diameter of the tube. For this purpose, the die has a mandrel that is adjustable relative to the sheathing surrounding it, whereby this mandrel can be tilted.

### BRIEF DESCRIPTION OF THE DRAWINGS

The Figure shows a schematic flow chart of a method according to the present invention.

### DETAILED DESCRIPTION

An object of the present invention is to provide a simple method for the production of electric conductors with different outer circumferences or cross sectional shapes. A farther or alternate object of the present invention is to provide a device for the production of such electric conductors.

Hence, according to the invention, a method is provided with which the at least one bore of the single-layer or multi-layer extrusion head is changed in order to set different conductor diameters or layer thicknesses during the production process. In this manner, it is now possible for the first time to achieve a flexible production of different electric conductors without a need for retooling the extrusion head and the end gasket, as is necessary with the state of the art. Moreover, this avoids an undesired loss of material and the need to keep extrusion head inserts in stock for each requisite bore and end gaskets, whereby the jacket that is configured as a CV pipe encloses the conductor for purposes of continuous vulcanization and is located between the extrusion head inserts and the end gaskets.

The Figure illustrates schematically one preferred method for producing an electrically insulated conductor having a sheathing made of one or more thermoplastic materials. In a first step, an extrusion head is provided having at least one bore that determines an outer circumference of the conductor and associated with one or more ring-shaped outlet cross sections, the bore determining a respective cross sectional area of the sheathing layers. See block 10. In a second step, the conductor is surrounded by a tubular jacket that encloses and seals a gaseous medium in an area between the extrusion head and an end gasket. See block 11. During the production process, the at least one bore of the extrusion head is changed so as to set at least one of a different conductor diameter and a different layer thickness. See block 12.

The adaptation of the bore to the desired product can be carried out when the device is at a standstill. In contrast, it is especially advantageous for the bore to be changed without interruption or delay of production so that, in particular, any loss of time can be avoided. The possibility of production loss is limited to the time needed to set a control element that changes the bore in order to reach the predetermined position.

According to another modification that is likewise very promising, the bore can be changed steplessly and continuously so that, on the one hand, any desired size can be produced and, on the other hand, a continuous material flow and an interruption-free production process can be ensured.

It is also especially practical if the end gasket is provided with a bore that accommodates the sheathed electric conductor and that is changed in accordance with the outer diameter of the extrusion head, whereby the end gasket that limits the inlet is adjusted in a manner that is time-shifted relative to the bore. In this way, the material loss can be reduced to a minimum in that the bore of the end gasket is changed in a time-shifted manner relative to the passage time of the conductor between the bore of the extrusion head and the bore of the end gasket. In particular, this avoids a material loss along the length of the jacket configured as a CV pipe for purposes of continuous vulcanization.

Fundamentally, the outer circumference of the insulated conductor or of the cores can be changed during the production process in order to, for example, achieve insulation properties that are adapted along the length of the conductor to the application purpose. In contrast, it is especially practical if the conductor or the cores provided with a sheathing are produced at a constant diameter.

The second-mentioned objective—namely, of creating a device for the production of electrically insulated conductors, especially current-carrying lines, having a sheathing made of one or more thermoplastic materials, whereby the device has a single-layer or multi-layer extrusion head having at least one given bore that determines the outer circumference of the conductor and that is associated with one or more ring-shaped outlet cross sections, said bore determining the appertaining cross section surface area of the sheathing layers, whereby in an area between the single-layer or multi-layer extrusion head and an end gasket, the conductor is surrounded by a tubular jacket that encloses and seals a gaseous medium—is achieved according to the invention in that the bore can be varied, especially the bore can have one or more variable bore sizes. In this manner, it becomes possible for the first time to set almost any desired bore openings within a short period of time, especially by means of a central control unit. On the one hand, the circumference can be varied and on the other hand, the cross section surface area or cross section form can be varied.

The bore could be flexibly shaped and configured so as to be variable by means of a control element. However, it is especially practical if at least one bore opening has movable, adjustable contact elements that can be laid against the outer circumference of the conductor and of the layers. This translates into a simple adjustability of the contact element surface characteristics that have been adapted to the shaping properties which, for this purpose, can be adjusted, for example, according to the principle of an iris diaphragm.

For example, such a variable bore can be created by means of several radially movable segments arranged on the circumference and connected especially to a cuff, especially a bellows, that can be laid against the circumference, so that the sealing effect can be improved in this manner. Moreover, a ring-shaped closed element similar to a hose clamp, could be provided that can be varied steplessly by means of a control element. Moreover, the opening could be enclosed by means of a grate that encloses the circumference and whose intersecting grate bars can be moved relative to each other in order to set the desired circumference.

Moreover, the contact elements can be elastically deformed so as to achieve an optimal adaptation to the desired contour and, in particular, to be able to realize steady transitions between adjacent contact elements.

Here, it is especially advantageous if the contact elements are arranged so as to overlap with each other. This prevents the separation site from forming a seam line, which would be undesired.

Another likewise especially advantageous embodiment of the present invention is achieved in that the area between the extrusion head and the end gasket is exposed to a gaseous medium enclosed by the jacket at an excess pressure between 5 bar and 15 bar, especially 10 bar. This ensures an optimal surface characteristics of the cores. Here, the extrusion head and the end gasket can be arranged in different planes so that the conductor assumes an oblique orientation and, in particular, follows a catenary curve.

Moreover, it has proven to be especially advantageous if the bore and the end gasket can be varied synchronously or time-shifted by means of a control unit in order to change the end gasket with such a time delay that conductor material located in the area between the extrusion head and the end gasket can be used without any limitations. Here, the continuous production process is not interrupted.

What is claimed is:

1. A method for producing an electrically insulated conductor having a sheathing made of one or more thermoplastic materials, the method comprising:
providing an extrusion head having at least one bore that determines an outer circumference of the conductor and associated with one or more ring-shaped outlet cross sections, the bore determining a respective cross sectional area of the sheathing layers;
surrounding the conductor by a tubular jacket that encloses and seals a gaseous medium in an area between the extrusion head and an end gasket; and
changing the at least one bore of the extrusion head during the production process so as to set at least one of a different conductor diameter and a different layer thickness.

2. The method as recited in claim 1, further comprising adjusting the end gasket variably to a respective outer diameter of the conductor being provided with the sheathing.

3. The method as recited in claim 1, wherein the conductor is a current-carrying line.

4. The method as recited in claim 1, wherein the extrusion head is one of a single-layer and a multi-layer extrusion head.

5. A method for producing production an electrically insulated conductor having a sheathing made of one or more thermoplastic materials, the conductor being surrounded by a tubular jacket that encloses and seals a gaseous medium by means of an end gasket, the method comprising:
adapting the end gasket variable using a variable bore the end gasket to a respective outer diameter of the conductor being provided with the sheathing.

6. The method as recited in claim 1, wherein changing of the at least one bore is performed without interruption or delay of production.

7. The method as recited in claim 1, wherein the changing of the at least one bore is performed steplessly.

8. The method according to at least one of the preceding claims, wherein the changing of the at least one bore is performed continuously.

9. The method as recited in claim 1, wherein the adjusting of the end gasket is performed in a manner that is time-shifted relative to the bore.

10. The method as recited in claim 1, wherein the conductor provided with a sheathing is produced at a constant diameter.

11. A device for producing an electrically insulated conductor having a sheathing made of one or more thermoplastic materials, the device comprising:
an extrusion head having at least one given bore that determines an outer circumference of the conductor and that is associated with one or more ring-shaped outlet cross sections, the bore determining a respective cross sectional area of the sheathing layers whereby, in an area between the single-layer or multi-layer extrusion head and an end gasket, the conductor is surrounded by a tubular jacket that encloses and seals a gaseous medium, wherein the at least one bore of the extrusion head is changeable during the production process in order to set at least one of a different conductor diameter and a different layer thicknesses.

12. The device as recited in claim 11, wherein the extrusion head is one of a single-layer and a multi-layer extrusion head.

13. The device as recited in claim 11, wherein the conductor is a current-carrying line.

14. A device for producing an electrically insulated conductor having a sheathing made of one or more thermoplastic materials, the device comprising:
an end gasket, the conductor being surrounded by a tubular jacket that encloses and seals a gaseous medium by means of the end gasket, the end gasket having a variable bore for purposes of attaining variable adaptation to the appertaining outer diameter of the conductor provided with the sheathing.

15. The device as recited in claim 11, wherein the at least one bore has a plurality of movable, adjustable contact elements that can be laid against the outer circumference of the conductor.

16. The device as recited in claim 15, wherein the contact elements can be elastically deformed.

17. The device as recited in claim 15, wherein the contact elements are arranged so as to overlap with each other.

18. The device as recited in claim 11, wherein the end gasket includes a variable bore and wherein the at least one bore and the variable bore of the end gasket are configured to be varied synchronously or time-shifted using a control unit.
